(19) United States
(12) Patent Application Publication
(10) Pub. No.: US 2020/0134453 A1
(43) Pub. Date: Apr. 30, 2020

(54) LEARNING CURVE PREDICTION APPARATUS, LEARNING CURVE PREDICTION METHOD, AND NON-TRANSITORY COMPUTER READABLE MEDIUM

(71) Applicant: Preferred Networks, Inc., Tokyo-to (JP)

(72) Inventors: Yutaka KITAMURA, Tokyo-to (JP); Shin-ichi MAEDA, Tokyo-to (JP)

(73) Assignee: Preferred Networks, Inc., Tokyo-to (JP)

(21) Appl. No.: 16/663,138

(22) Filed: Oct. 24, 2019

(30) Foreign Application Priority Data
Oct. 25, 2018 (JP) 2018-201189

(51) Int. Cl. G06N 3/08; G06N 3/04; G06N 7/00

(52) U.S. Cl. CPC G06N 3/08; G06N 7/005; G06N 3/0454

(57) ABSTRACT

A device for shortening time for learning curve prediction includes a sampler, a learning curve predictor, a learning executor, and a learning curve calculator. The sampler samples a weight parameter of a parameter model which outputs a parameter of a learning curve model of a neural network (NNW) on the basis of a set value of a hyperparameter of the NNW. The learning curve predictor calculates a prediction learning curve of the NNW on the basis of the sampled weight parameter and an actual learning curve of the NNW. The learning executor advances learning in the NNW. The learning curve calculator calculates an actual learning curve resulting from the advance of the learning in the NNW. The learning curve predictor updates the prediction learning curve of the NNW on the basis of the weight parameter sampled before the learning advances and the actual learning curve calculated after the learning advances.

### TECHNICAL FIELD

The present invention relates to a learning curve prediction apparatus, a learning curve prediction method, and a nonvolatile storage medium.

### BACKGROUND ART

A neural network has hyperparameters which need to be set before learning of weight parameters begins. For example, the hyperparameters include those regarding the structure of the network, such as the number of intermediate layers, the number of units in each layer, a method of combining the weight parameters. Further, a parameter such as step size included in a learning algorithm also falls under a hyperparameter. Depending on set values of these hyperparameters, the performance of the neural network after the learning greatly differs even if the same volume of training data is used. Therefore, studies have been made on a method to optimize hyperparameters.

Conventional methods, however, have problems such as a required time is too long. Therefore, to shorten the time required, studies have been made on a method to reduce the total calculation volume by predicting a learning curve. However, since the learning curve prediction also requires a long time, the time required is not sufficiently reduced, and contrary to the intention, there has occurred a new problem of degradation in optimization precision.

### PRIOR ART LITERATURE

### Non-Patent Literature

[Non-patent literature 1] Lisha Li and four others, “Hyperband: A Novel Bandit-Based Approach to Hyperparameter Optimization”, Journal of Machine Learning Research, 2018, p. 1-52
[Non-patent literature 2] Aaron Klein and three others, “Learning Curve PREDICTION WITH BAYESIAN NEURALNETWORKS”, conference paper at ICLR, 2017
[Non-patent literature 3] KEVIN SWERSKY and two others, “FREEZE-THAW BAYESIAN OPTIMIZATION”, Jun. 14, 2014, arXiv 1406.3896, vl, [stat. ML]
[Non-patent literature 4] Christopher M. Bishop, “PATTERN RECOGNITION AND MACHINELEARNING”, Springer Science+Business Media, 2006

### SUMMARY OF THE INVENTION

### Problem to be Solved by the Invention

An embodiment of the present invention provides a device in which the time required for learning curve prediction is shortened.

### Means for Solving the Problem

An embodiment of the present invention includes a sampler, a learning curve predictor, a learning executor, and a learning curve calculator. The sampler samples a weight parameter of a parameter model which outputs a parameter of a learning curve model of a neural network (NNW) on the basis of a set value of a hyperparameter of the NNW. The learning curve predictor calculates a prediction learning curve of the NNW on the basis of the sampled weight parameter and an actual learning curve of the NNW. The learning executor advances learning in the NNW. The learning curve calculator calculates an actual learning curve resulting from the advance of the learning in the NNW. The learning curve predictor updates the prediction learning curve of the NNW on the basis of the weight parameter sampled before the learning advances and the actual learning curve calculated after the learning advances.

### BRIEF DESCRIPTION OF THE DRAWINGS

FIG. 1 a block diagram illustrating an example of a learning apparatus according to a first embodiment

FIG. 2 a schematic flowchart of initial processing in a hyperparameter search

FIG. 3 a schematic flowchart of main processing in the hyperparameter search

FIG. 4 a schematic flowchart of processing in Iteration

FIG. 5 a block diagram illustrating an example of a hardware configuration in one embodiment of the present invention

### EMBODIMENTS FOR CARRYING OUT THE INVENTION

Embodiments of the present invention will be hereinafter described with reference to the drawings.

### First Embodiment

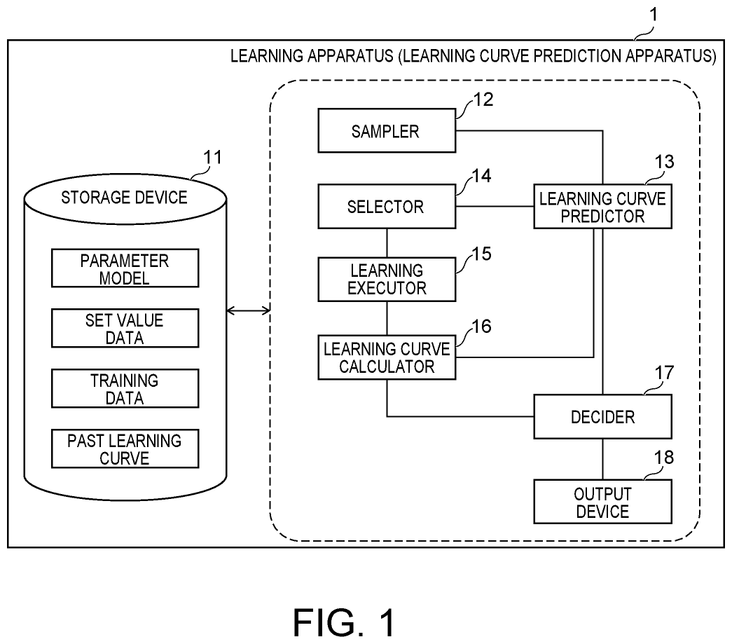

FIG. 1 is a block diagram illustrating an example of a learning apparatus (learning curve prediction apparatus) according to a first embodiment. The learning apparatus (learning curve prediction apparatus) 1 according to the first embodiment includes a storage device 11, a sampler 12, a learning curve predictor 13, a selector 14, a learning executor 15, a learning curve calculator 16, a decider 17, and an output device 18.

The learning apparatus 1 of this embodiment predicts learning curves of evaluation indexes regarding given Neural Networks (NNWs) and executes a hyperparameter search.

The learning curve refers to a graph that is a representation of a set of points each being a combination of an epoch and an evaluation index, with the epoch taken on the horizontal axis and with the evaluation index taken on the vertical axis. Note that the number of the sets of the points each consisting of the epoch and the evaluation index may be one. That is, the number of plots of the learning curve may be only one. The hyperparameter search is to estimate an optimum hyperparameter, that is, an optimum set value (optimum value) of a hyperparameter of a neural network. It is possible to find the optimum set value of the hyperparameter by predicting learning curves corresponding to hyperparameters which are candidates for the optimum set value. Therefore, it can be said that the learning apparatus 1 is a learning curve prediction apparatus or a hyperparameter estimation apparatus.

The hyperparameter is a parameter not calculated through learning, but is, out of parameters of a neural network a parameter that needs to be decided prior to the start of learning. Since a neural network has a plurality of hyperparameters, a row of the set values of the hyperparameters is represented by x, and will be hereinafter referred to simply as a set value x. For example, in a case where a neural network has M hyperparameters (M is an integer equal to or more than 1), the set value x means x={x₁, x₂, x₃, . . . , x_{M}}

The kind of a neural network for which the hyperparameter search is performed is not limited. For example, it may be CNN (Convolutional Neural Network), RNN (Recurrent Neural Network), or the like.

The optimum value of a hyperparameter can be inferred from a plurality of set values, but generally, the performances of neural networks corresponding to the plurality of set values need to be known. For example, in a case where an optimum value of a hyperparameter is inferred from N set values (N is an integer equal to or more than 1), some conventional method completes learning in N neural networks corresponding to these set values and then evaluates the performances of the N neural networks. Since it takes a long time to complete the learning, this method is inefficient.

Therefore, in this embodiment, to shorten the time required for the hyperparameter search, a learning curve of a certain evaluation index is predicted regarding a neural network in which learning is carried out. If a future development of the learning curve can be predicted during the learning period, it is possible to determine, without completing the learning, what performance the neural network will have after completing the learning. That is, in this embodiment, during the learning, the promisingness of a neural network (or it can be said as the promisingness of a hyperparameter) is determined.

First, a learning curve prediction method used in this embodiment will be described. It is known that a learning curve can be expressed by a learning curve model of the following formula.

$$\begin{matrix}[ math . 1 ] & \\ f ( t ; α , β , μ ) = μ + {\sum }_{i = 1}^{K} {α}_{i} {φ}_{i} ( t ; {β}_{i} ) & ( 1 )\end{matrix}$$

ϕᵢ(t;β₁) represents an i-th basis function (i is an integer equal to or more than 1) and depends on epoch number t and a parameter vector βᵢ of the i-th basis function. Here, let us suppose that there are K basis functions (K is an integer equal to or more than i). The number K of the basis functions is appropriately adjusted. Conceivable basis functions are sigmoid or the like. Further, αᵢ represents a weight to the i-th basis function ϕᵢ, and the weight of each of the basis functions is represented by a connection vector α. Further, β represents a combined vector of parameter vectors of each of the basis functions. μ represents a constant.

An evaluation index of a neural network is represented by y_{x,t} when the set value of the hyperparameter is x and the epoch number is t (t is an integer equal to or more than 0). It is assumed that the evaluation index is precision, but the evaluation index may be one from which the goodness of the neural network can be objectively evaluated, that is, may be one from which the neural network performance which varies depending on the epoch number can be evaluated.

From learning curves which have already been obtained when the epoch number reaches τ (τ is an integer equal to or more than 0), the evaluation index y_{x,t} at the t epoch (here, t>τ, that is, later than the τ epoch), that is, a learning curve after the τ epoch is predicted using the aforesaid learning curve model.

The future learning curve of the evaluation index y_{x,t} has uncertainty. The uncertainty can be expressed by a probability model of the following formula.

[math. 2]

p(y_{x,t}|α,β,μ,σ²)=N(f(t;α,β,μ),σ²) (2)

σ² is a constant representing the variance of noise included in the probability model, that is, noise included in the learning curve model.

A neural network is prepared which has learned in advance so as to output parameters of the learning curve model, that is, the connection vector α, the combined vector ß, the constant μ, and σ² when the set value x of the hyperparameter is input to the neural network. The neural networks will be hereinafter referred to as a parameter model. The parameter model is a neural network simpler than the neural network for which the hyperparameter search is performed. Weight parameters of the parameter model are each represented by a vector W.

The parameters of the learning curve model can be expressed by α=α(x;W), ß=ß(x;W), μ=μ(x;W), and σ²=σ²(x;W) as functions with respect to the set value x of the hyperparameter and the weight parameter W. Accordingly, the probability model is expressed by the following formula.

[math. 3]

p(y_{x,t}|W)=N(f(t;α(x;W),β(x;W),μ(x;W)),σ²(x,W)) (3)

Since the optimum value of the weight parameter W is not known, the probability model is marginalized with respect to the weight parameter W to be converted into a probability model based on observation data.

[math. 4]

p(y_{x,t}|W)=N(f(t;α(x,W),β(x,W),μ(x,W)),σ²(x,W)) (4)

The vector Y_{x,τ} is a row of evaluation indexes in epochs up to the τ epoch, of the neural network whose hyperparameter has the set value x. That is, the vector Y_{x,τ} is a learning curve up to the τ epoch of the neural network having the set value x. The vector D is a set of rows of evaluation indexes of a plurality of neural networks having hyperparameters whose set values are not x. That is, the vector D is a set of learning curves. The vector D is obtained before the hyperparameter search, through learning in the plurality of neural networks whose set values are not x. That is, the vector D is observation data.

Since the integration of the right side of Formula (4) can be approximated by the Monte Carlo method, Formula (4) can be expressed by the following formula.

$$\begin{matrix}[ math . 5 ] & \\ p ( {y}_{x , t} \vert {Y}_{x , τ} , D ) ≃ \frac{1}{K} {\sum }_{i = 1}^{K} p ( {y}_{x , t} \vert {W}_{i} ) & ( 5 ) \\ {W}_{i} ∼ p ( W \vert {Y}_{x , τ} , D ) & \end{matrix}$$

This indicates that it is possible to calculate the probability distribution p(y_{x,t}|Y_{x,τ}, D) by sampling K weight parameters from the probability distribution p(W|Y_{x,τ}, D) and using their sampling values.

However, in Formula (5), the weight parameters W are sampled from the probability distribution p(W|Y_{x,τ}, D). Therefore, when the learning in the neural network whose hyperparameter has the set value x advances from the τ epoch to τ′ epoch, the sampling from a probability distribution p(W|Y_{x,τ′}, D) is necessary. That is, every time the learning advances, the probability distribution p(W|Y_{x,τ}, D) has to be updated on the basis of the latest learning curve to execute the sampling. The sampling takes about several minutes even if GPU is used. On the other hand, the time taken for learning in one epoch is on the order of several seconds. Therefore, the sampling is a bottleneck, or there may occur a problem that the calculation is executed using a previous sampling value by mistake.

Therefore, this embodiment does not use Formula (5), thereby avoiding the sampling from the probability distribution p(W|Y_{x,τ}, D). The probability distribution p(W|Y_{x,τ}, D) is broken down as follows.

[math. 6]

p(W|Y_{x,τ},D)∝p(Y_{x,τ}|W,D)p(W|D) (6)

If Formula (6) is substituted in Formula (4), the following formula holds.

[math. 7]

p(y_{x,t}|Y_{x,τ},D)∝∫p(y_{x,t}|W)p(Y_{x,τ}|W,D)p(W|D)dW (7)

As is done in the above, Formula (7) is approximated by the Monte Carlo method. The approximate formula is adjusted with a normalization constant and is expressed by the following formula.

$$\begin{matrix}[ math . 8 ] & \\ p ( {y}_{x , t} \vert {Y}_{x , t} , D ) ≃ \frac{C}{K} {\sum }_{i = 1}^{k} p ( {Y}_{x , τ} \vert {W}_{i} ) p ( {y}_{x , t} \vert {W}_{i} ) & ( 8 ) \\ {W}_{i} ∼ p ( W \vert D ) & \end{matrix}$$

In Formula (8), unlike the aforesaid case, the weight parameters are sampled not from the probability distribution p(W|Y_{x,τ}, D) but from the probability distribution p(W|D). This eliminates a need for the resampling even if the learning in the neural network having the set value x advances. This enables the quick prediction of the probability distribution p(y_{x,t}|Y_{x,τ}, D), that is, the learning curve after the τ epoch. Therefore, the efficient search for the optimum hyperparameter can be possible.

As a sampling method of the weight parameters W, a method such as SGLD (Stochastic Gradient Langevin Dynamics), SGHMC (Stochastic Gradient Hamilton Monte Carlo), or the like can be used, for instance. A sampling method other than these may be used.

The outline of the constituent elements of the learning apparatus 1 will be described. The storage device 11 stores data necessary for the processing of the hyperparameter search. Examples of the necessary data include: training data used when the learning in the parameter model or the neural networks is advanced; and learning curves which correspond to hyperparameters tried so far and are to be used in the learning curve prediction.

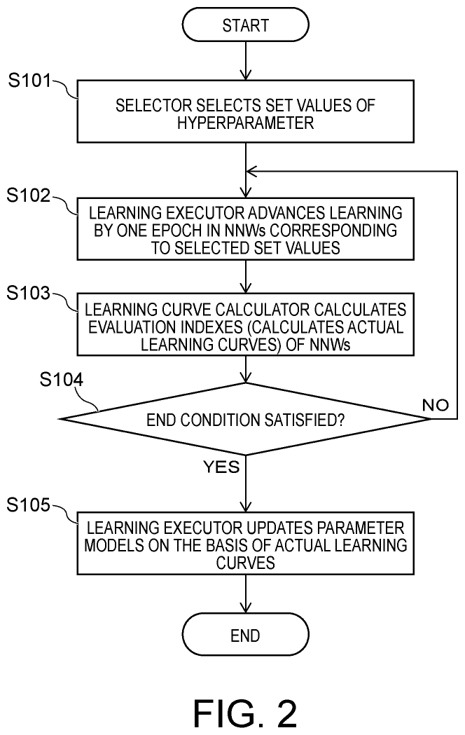

Further, let us suppose that data including a plurality of set values are recorded as the necessary data. The data will be referred to as set value data. The set values included in the set value data are different from one another. For example, let us suppose that the set value data includes a first set value x₁ (x₁={x₁₁, x₁₂, . . . , x_{1M}}) and a second set value x₂ (x₂={x₂₁, x₂₂, . . . , x_{2M}}). In this case, out of combinations of corresponding elements of the first set value x₁ and the second set value x₂ (x₁₁ and x₂₁, x₁₂ and x₂₂, . . . x_{1M} and x_{2M}), there is a difference in at least one combination. The set value data may be generated by a device outside the learning apparatus 1 or may be generated by a constituent element of the learning apparatus 1, such as the selector 14. How the set value data is used will be described with reference to the flowcharts in FIG. 2 to FIG. 4.

It should be noted that the data stored in the storage device are not limited. For example, processing results of the constituent elements of the learning apparatus 1 may be stored in the storage device 11 whenever necessary, and the constituent elements may obtain the processing results by referring to the storage device 11.

The sampler 12 samples the weight parameters W of the parameter model on the basis of the probability distribution p(W|D) as is shown in Formula (8). As described above, the sampling is not performed every time the learning advances. The sampling only needs to be performed before the learning curve predictor 13 first predicts a learning curve. It should be noted that performing the resampling when the learning advances to a certain degree is allowed since a calculation amount in this case is smaller than that when the sampling is performed every time the learning advances by one epoch.

The learning curve predictor 13 calculates a probability distribution p(Y_{x,τ}|Wᵢ) and a probability distribution p(y_{x,t}|Wᵢ) using the weight parameters which are sampled on the basis of the probability distribution p(W|D), and finally calculates p(y_{x,t}|Y_{x,τ}, D) as shown in Formula (8). More specifically, the learning curve predictor 13 sets the sampled weight parameters in the parameter model and obtains the connection vector α, the combined vector ß, the constant μ, and the constant σ² which are the parameters of the learning curve model, from the parameter model in which the sampled weight parameters are set. Then, using the obtained parameters regarding the learning curve, it calculates the probability distribution p(Y_{x,τ}|Wᵢ) and the probability distribution p(y_{x,t}|Wᵢ) and finally calculates p(y_{x,t}|Y_{xτ},D). That is, the learning curve predictor 13 predicts the learning curve that is supposed to be obtained after the τ epoch, on the basis of the sampled weight parameters and the learning curve in the learning up to the τ epoch. Note that the predicted learning curve will be referred to as a prediction learning curve. Further, a learning curve that is not the prediction learning curve will be referred to as an actual learning curve. That is, the learning curve predictor 13 calculates the prediction learning curve on the basis of the sampled weight parameters and the actual learning curve.

The prediction learning curve is calculated every time the learning advances. That is, the prediction learning curve is updated every time the learning advances. The actual learning curve used for the prediction learning curve is also calculated every time the learning advances, but the sampling need not be performed every time the learning advances. Therefore, it can be said that the learning curve predictor 13 updates the prediction learning curve on the basis of the weight parameters sampled before the learning advances and the actual learning curve calculated after the learning advances.

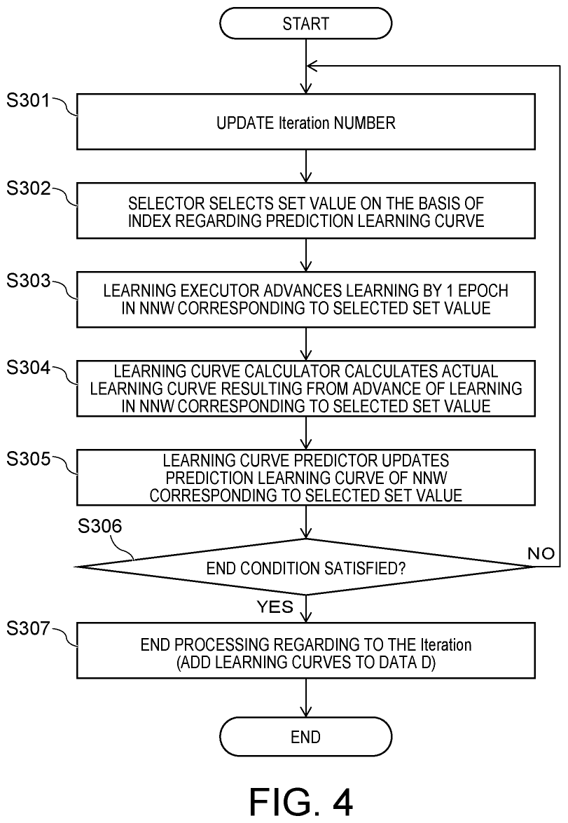

The selector 14 selects set values that are to be used in the processing, from the plurality of set values. For example, the set values which are search targets this time are selected from the set value data. The selector 14 further selects a set value from the set values which are the search targets, on the basis of the index regarding the prediction learning curve. Note that the learning is advanced in a neural network corresponding to the selected set value, which will be described in detail with reference to the flowchart in FIG. 4. Therefore, it can be said that the selector 14 selects the neural network in which the learning is to be advanced, from a plurality of neural networks having different hyperparameters, on the basis of the indexes regarding the prediction learning curves. This index will be described later.

The learning executor 15 executes the learning in a designated neural network, on the basis of the training data. The description will be given on assumption that the learning advances epoch by epoch, but a unit of the advance of the learning need not be one epoch. Further, the learning executor 15 updates the weight parameters W of the parameter model, using the actual learning curve resulting from the completion of the learning as observation data D.

The learning curve calculator 16 calculates the actual learning curve of the designated neural network. That is, every time the learning advances, the learning curve calculator 16 calculates an actual evaluation index in the current epoch, on the basis of not the learning curve model but the training data.

On the basis of at least the prediction learning curve or the actual learning curve, the decider 17 decides, as a promising neural network, at least one neural network out of the plurality of neural networks. For example, an actual learning curve satisfying a predetermined condition may be detected and a neural network corresponding to this learning curve may be decided as promising. Then, on the basis of the promising neural network, the optimum hyperparameter is decided. For example, on the basis of the set values and performances of the promising neural network, the optimum value may be calculated using a known method such as a gradient method. Another adoptable method is to decide the best learning curve and decide a neural network corresponding to this learning curve as promising (optimum). Then, the set value itself of the promising neural network may be decided as the optimum value, or a value obtained after the set value is adjusted may be decided as the optimum value.

The output device 18 outputs the processing results of the constituent elements. For example, the optimum value of the hyperparameter, the optimum neural network, and so on which are the decision results of the decider 17 can be output.

Next, the processing of each of the constituent elements will be described in detail along the flow of the processing. FIG. 2 is a schematic flowchart of initial processing in the hyperparameter search. This flow is executed to obtain the observation data D.

The selector 14 selects a plurality of set values from set value data of a hyperparameter (S101). For example, about several ten set values may be selected. A selecting method is not limited and the selection may be made at random.

The learning executor 15 advances learning by one epoch in a plurality of neural networks corresponding to the selected set values (S102). Then, the learning curve calculator 16 calculates evaluation indexes resulting from the advance of the learning in the neural networks (S103). If an end condition is not satisfied, for example, if the epoch number does not reach an upper limit value (τ epoch, T is an integer equal to or more than 1) (NO at S104), the processes of S102 and S103 are repeated. That is, the learning is advanced by another one epoch and evaluation indexes resulting from the advance of the learning are calculated. In this manner, the evaluation indexes in the respective epochs are calculated, whereby the actual learning curves are calculated. The calculated actual learning curves are used as the observation data D. Note that the end condition may be other than a condition regarding the upper limit value. Further, the upper limit value of the epoch number may be appropriately set. The same also applies to the other end conditions which will be described later.

If the end condition is satisfied (YES at S104), the learning executor updates the parameter model on the basis of the actual learning curves (S105). That is, the probability distribution p(W|D) is updated.

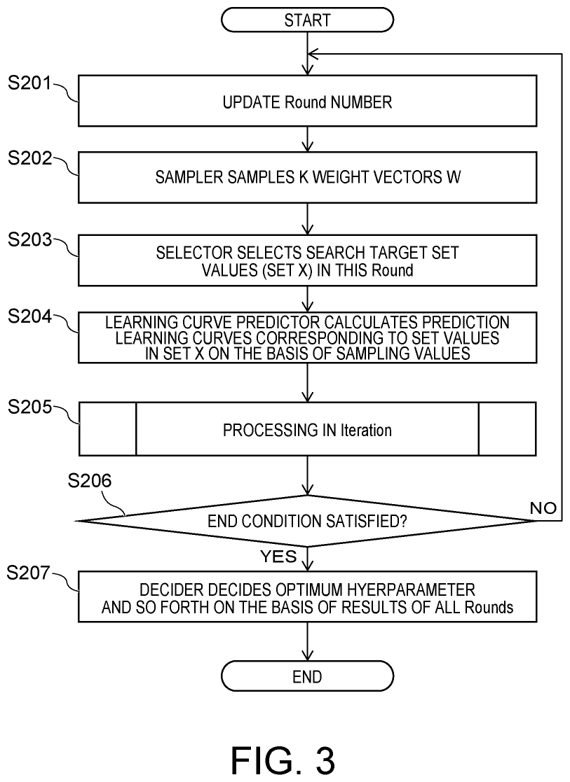

FIG. 3 is a schematic flowchart of main processing in the hyperparameter search. After the end of the initial processing, this main processing is performed.

In this flow, a promising set value is inferred from the set value data of the hyperparameter. However, the plurality of values included in the set value data of the hyperparameter are not searched at one time, but a range of search target set values is narrowed, and the search is performed separately a plurality of times. One search is called a “Round”, and the number of search times is referred to as Round number. By dividing the search into a plurality of Rounds, processing results in some Round can be used in the next Round. For example, actual learning curves calculated in some Round can be used as the observation data D in the next Round.

Further, in a neural network determined as promising in a Round on the basis of its prediction learning curve, out of the plurality of neural networks corresponding to the plurality of set values, learning is advanced. Learning is not advanced in neural networks that are not determined as promising. Further, the learning need not be completed in all the neural networks. This reduces the number of neural networks in which learning is executed, enabling a reduction in the time required for the hyperparameter search. Further, a waste of calculation resources can be reduced.

The determination on the promisingness and the advance of the learning are repeated in one Round. This repetition is called “Iteration”, and the number of repetition times is referred to as the Iteration number.

First, the Round number is updated (S201). The sampler 12 samples the K weight parameters W on the basis of the probability distribution p(W|D) (S202). The selector 14 selects set values that are to be search targets in this Round (S203). For example, about several ten to about several hundred set values can be selected. A set of the selected set values is represented by X. The set values may be selected at random or may be selected using a method such as TPE (Tree-Structured Parzen Estimator). Then, the learning curve predictor 13 calculates prediction learning curves corresponding to the set values in the set X (S204).

Then, processing in the Iteration is performed (S205). FIG. 4 is a schematic flowchart of the processing in the Iteration. First, the Iteration number is updated (S301). The selector 14 selects at least one of the set values on the basis of the index regarding the prediction learning curve (S302). The learning executor 15 advances learning by one epoch in a neural network corresponding to the selected set value (S303). The number of the neural networks in which the learning is thus advanced may be one or may be plural.

The index regarding the prediction learning curve may be one indicating whether the prediction learning curve is good. For example, EI (Expected Improvement), PI (Probability of Improvement), or the like in some epoch which is larger than the current epoch number and is within a range equal to or less than the upper limit value of the epoch number may be used. Instead, an original index may be used.

CEI which is an original index by the inventors will be described. CEI(x) for a neural network having a hyperparameter whose set value is x is expressed by the following formula.

$$\begin{matrix}[ math . 9 ] & \\ CEI ( x ) = {max}_{t = {t}_{x} + 1 , {t}_{x} + 2 , … T} \frac{EI ( x , t )}{t - {t}_{x}} & ( 9 )\end{matrix}$$

tₓ represents the current epoch number in the neural network having the set value x. Note that, since the learning is advanced only in the neural networks corresponding to the selected set values, the current epoch numbers of the neural networks corresponding to the set values are not the same.

Note that the expected improvement EI (x,t) in Formula (9) is expressed by the following formula.

$$\begin{matrix} [ math . 10 ] & \\ EI ( x , t ) = {E}_{{y}_{x , t}} [ max ( {y}_{x , t} - {y}^{BEST} , 0 ) ] = \int p ( {y}_{x , t} \vert {Y}_{x , τ} , D ) ( max ( {y}_{x , t} - {y}^{BEST} , 0 ) ) {dy}_{x , t} & ( 10 )\end{matrix}$$

y^{BEST} represents the best value out of all the evaluation indexes calculated in all the ROUNDs executed so far. Note that, in a case where the evaluation index is a difference between the actual learning curve and the learning curve model, the minimum value is the best value, and in a case where it is a match percentage between the actual learning curve and the learning curve model, the maximum value is the best value. Note that EI(x,t) may also be expressed by the following formula.

[math. 11]

EI(x,t)=E_{y}_{_{x,t}}[max(min(y_{x,t},1)−y^{BEST},0)] (11)

Since the distribution of the evaluation index y_{x,t} is a Gaussian mixture distribution as is seen from the above-described learning curve prediction method, EI(x,t) in Formula (10) and Formula (11) can both be calculated analytically.

As described above, CEI(x) represents the maximum value out of values each equal to the expected improvement EI(x,t) in each epoch which is larger than the current epoch number tₓ and is within the range equal to or less than the upper limit value T of the epoch number, divided by a difference value (t−tₓ) between the epoch and the current epoch number. That is, CEI is an index indicating a future gradient in a graph plotted as the best value of all the evaluation indexes calculated in all the ROUNDs executed so far, with respect to the number of epochs consumed in all the ROUNDs executed so far. A set value under which this gradient is large, that is, a set value under which the best value of all the evaluation indexes is expected to be updated most sharply is preferentially selected. An ordinary index has a problem that a neural network whose evaluation index is bad in the initial period of learning but is very good in the final period is not likely to be selected. On the other hand, in CEI, whole of the future learning periods (from tₓ₊₁ to T) are taken into consideration, and therefore, it is possible to select a neural network whose evaluation index is bad in the initial period of learning but is very good in the final period. As described above, the use of an index like CEI also enables the selector 14 to select a neural network in which learning is to be preferentially advanced.

After the learning in the neural network corresponding to the set value selected in this manner advances, the learning curve calculator 16 calculates an actual learning curve resulting from the advance of the learning (S304). Then, the learning curve predictor 13 updates the prediction learning curve on the basis of the weight parameters sampled before the learning advances and the actual learning curve resulting from the advance of the learning (S305).

If end condition regarding to the Iteration is not satisfied, for example, if the Iteration number does not reach an upper limit value (NO at S306), the processes from S301 to S305 are repeated. That is, a new set value is selected from the set X, followed by the processing under the new set value. If the end condition regarding to the Iteration is satisfied (YES at S306) as the end processing regarding to the Iteration is thus performed, end processing regarding to the Iteration is performed (S307). In the end processing regarding to the Iteration, the actual learning curves calculated in the Iterations are added to the observation data D. That is, P(W|D) is updated as is done at S105. Further, the initialization of the Iteration number, and so on are performed.

Let us return to the explanation of FIG. 3. After the processing in the Iteration (S205), an end condition of the Round is checked. If the end condition of the Round is not satisfied, for example, if the Round number does not reach an upper limit value (NO at S206), the processing returns to S201, where the processing in a new Round is started. Since the observation data D has been added in the end processing regarding to the Iteration (S307), it is possible to calculate prediction learning curves in the new Round more precisely than in the previous Round. If the end condition of the Round is satisfied (YES at S207), all the searches are ended, and the decider 17 decides a promising neural network, optimum hyperparameters, and so forth on the basis of the results of all the Rounds (S207).

It should be noted that the flowcharts in this description are only examples and are not limited to the above examples. The sequence change, addition, and omission in the procedures may be made in accordance with the specification, changes, or the like required in an embodiment. For example, it is assumed that the sampling (S202) is performed only before the processing of calculating the prediction learning curves (S204), but it is also possible to perform the sampling again when the Iteration number reaches a predetermined number in the processing in the Iteration.

As described above, according to this embodiment, in the learning curve prediction, the resampling is not performed every time learning advances but the weight parameters sampled before the learning advances are used. This can shorten the time required for the learning curve prediction.

Further, according to this embodiment, since the promisingness of the neural network can be determined from the prediction learning curve, it is possible to advance the learning only in the neural network considered as promising. Since there are many hyperparameters in a neural network, the number of the set values x to be searched is further enormous. Accordingly, the hyperparameter search requires a very long time. Therefore, it is preferable to concentrate calculation resources on the neural network considered as promising as in this embodiment, thereby improving the efficiency of the hyperparameter search.

Further, there may be a case where a neural network not considered as promising at the beginning of learning is determined as promising as the learning advances. Therefore, if the neural network considered as promising is selected and learning is advanced therein, there is a risk that the optimum hyperparameter is decided without taking a hyperparameter of the neural network which will finally be competent into consideration. On the other hand, the use of the index CEI makes it possible to determine the promisingness of the neural network, taking whole of the future learning periods into consideration. This makes it possible to prevent the optimum hyperparameter from being decided without taking the hyperparameter of the neural network which will finally be competent into consideration.

### Second Embodiment

In the first embodiment, the promisingness of the set value x is determined through the estimation of the learning curve of each neural network in which the set value x is set as the hyperparameter. At this time, the weight parameters W of the parameter model are sampled before the learning in the neural network, the parameter model outputting the parameters (the connection vector α, the combined vector ß, the constant μ, and the constant σ²) of the learning curve model when the set value x is input thereto. Executing the sampling before the learning shortens the time required for the learning curve prediction but also increases the number of the sampling results which are not used to the last because they are not suitable for the learning curve prediction. That is, this may result in a larger number of the unused sampling results and poorer estimation precision of the learning curve model than performing the sampling every time learning advances.

Therefore, in the second embodiment, the influence of the sampling is reduced so that learning curve estimation precision degrades less than in the first embodiment. In the first embodiment, the sampled weight parameters W are set in the parameter model, and from the parameter model, the connection vector α, the combined vector ß, the constant μ, and the constant σ² which are the parameters of the learning curve model are obtained. In the second embodiment, at least one of the connection vector α and the constant μ is not obtained from the parameter model. In the second embodiment, the probability distribution of the evaluation index is changed so as to enable the learning curve prediction without using the learning curve-related parameter not obtained from the parameter model.

It should be noted that the parameter model used in the second embodiment may be different from those of the first embodiment or the same as those of the first embodiment. In the second embodiment, a parameter model that output only parameters used in the second embodiment may be used. Alternatively, in the second embodiment, only necessary parameters out of the parameters output from the parameter model of the first embodiment may be used.

The second embodiment is different from the first embodiment in details of the arithmetic operation by the learning curve predictor 13. Explaining this with reference to the flowchart illustrated in FIG. 3, details of the processing of calculating the prediction learning curves at S204 are different. The other points are the same as in the first embodiment. That is, constituent elements of a learning apparatus according to the second embodiment are the same as those of the first embodiment illustrated in FIG. 1. Further, as for the constituent elements of the learning apparatus according to the second embodiment, the flowchart illustrated in FIG. 1 is also the same as the flowcharts of the first embodiment illustrated in FIG. 2 to FIG. 4. Therefore, the illustration thereof in the second embodiment will be omitted.

Learning curve prediction in the second embodiment will be described. In the description of this embodiment, several notation forms are different from those of the first embodiment as follows for convenience of explanation.

Let us suppose that there are N kinds of set values under which learning has already been performed. The n-th (1≤n≤N) set value is represented by xⁿ={xⁿ₁, xⁿ₂, xⁿ₃, . . . , xⁿ_{M}}. An evaluation index corresponding to the set value xⁿ when the epoch number is t is represented by yⁿₜ. A row of evaluation indexes corresponding to the set value xⁿ in epochs is represented by Yⁿ={yⁿ₁, yⁿ₂, yⁿ₃, . . . , yⁿ_{τmax}}. Note that τmax represents the maximum epoch number of learning. τmax may differ depending on each set value xⁿ.

Further, a set value under which learning is currently performed and which is to be evaluated at the present is represented by x*={x*₁, x*₂, x*₃, . . . , x*_{M}}. A row of evaluation indexes corresponding to the set value x* in the epochs is represented by Y*={y*₁, y*₂, y*₃, . . . , y*_{τ}}. Y_{x,τ} of the first embodiment corresponds to Y*. Further, the connection vector α and so on, if the sign * is appended thereto, indicate that they correspond to the set value x*.

Note that a set value simply indicated by x means a set value in general and may be x* or may be xⁿ. This also applies to the vector Y and so on corresponding to the set value x.

Further, in this embodiment, observation data so far is handled as a combination of a set value of a hyperparameter and a row of evaluation indexes corresponding to this set value and is represented by D′^{ALL}. Observation data corresponding to the first to N-th set values is represented by D′^{N}={(xⁿ, Yₓⁿ)|n=1, 2, . . . , N}. Further, observation data corresponding to the set value x* is represented by D′*={(x*, Y*)}. The observation data D′ so far is represented by D′^{ALL}={D′*, D′^{N}}.

In the first embodiment, the parameters of the learning curve model are each expressed as a function with respect to the set value x of the hyperparameter and the weight parameter W. On the other hand, in this embodiment, the connection vector α and the constant μ are considered independently of the weight parameter W. Therefore, a posterior probability p(yₜ*|D′^{ALL}) of the evaluation index y*ₜ in the case where there is observation data D′^{ALL} is expressed as follows using the set value x*, the connection vector α*, the constant μ*, and the weight parameter W.

$$\begin{matrix} [ math . 12 ] & \\ p ( {y}_{t}^{*} \vert {D}^{′ ALL} ) = \int \int \int p ( {y}_{t}^{*} \vert {x}^{*} , {α}^{*} , {μ}^{*} , W ) p ( {α}^{*} , {μ}^{*} \vert {D}^{′ *} , W ) p ( W \vert {D}^{′ ALL} ) d {α}^{*} d {μ}^{*} dW = \int ( \int \int p ( {y}_{t}^{*} \vert {x}^{*} , {α}^{*} , {μ}^{*} , W ) p ( {α}^{*} , {μ}^{*} \vert {D}^{′ *} , W ) d {α}^{*} d {μ}^{*} ) p ( W \vert {D}^{′ ALL} ) dW & ( 12 )\end{matrix}$$

The probability distribution p(W|D′^{ALL}) in Formula (12) can be broken down into p(D′*|W,D′^{N})p(W|D′^{N}) similar to Formula (6). Then, by the same conversion as those into Formulas (7) and (8), the weight parameter W can be sampled before learning, from the observation data D′N not relevant to the current evaluation target set value x*. Further, owing to the sampling, the weight parameter W in the parentheses in Formula (12) can be regarded as a fixed value.

The arithmetic operation of the probability distribution p(α*,μ*|D′*,W) in the parentheses in Formula (12) will be described. First, let us assume that probability distributions of the connection vector α and the constant μ are expressed by the following formulas as Gaussian distributions.

[math. 13]

p(α)=N(α|M_{α},Λ_{α}⁻¹) (13)

p(μ)=N(μ|m_{μ},λ_{μ}⁻¹) (14)

M_{α} represents a homogeneous-dimension average vector with respect to the connection vector α. Λ_{α}⁻¹ is a precision matrix and represents an inverse matrix of a homogeneous-dimension covariance matrix with respect to the connection vector α. m_{μ} represents an average value of a positive constant μ. λ_{μ}⁻¹ represents precision in the positive constant μ and represents a reciprocal of the constant μ.

Further, for convenience' sake, the connection vector α and the constant μ are collectively represented by the vector Z shown in the following formula.

$$\begin{matrix}[ math . 14 ] & \\ Z = ( \begin{matrix}α \\ μ\end{matrix} ) & ( 15 )\end{matrix}$$

Further, on the basis of Formulas (13) and (14), the vector Z is also expressed by the following formula as a Gaussian distribution.

$$\begin{matrix}[ math . 15 ] & \\ p ( Z ) = N ( Z \vert {M}_{Z} , {Λ}_{Z}^{- 1} ) & ( 16 ) \\ {M}_{Z} = ( \begin{matrix}{M}_{α} \\ {m}_{μ}\end{matrix} ) , {Λ}_{Z}^{- 1} = ( \begin{matrix}{Λ}_{α}^{- 1} & 0 \\ {0}^{T} & {λ}_{μ}^{- 1}\end{matrix} ) & \end{matrix}$$

Where the set value x is given and the weight parameter W has been sampled and known, a probability distribution p(Y|Z) can be expressed by the following formula on the basis of Formulas (1) to (3). This indicates that the vector Y follows a conditional Gaussian distribution when the vector Z is given.

$$\begin{matrix} [ math . 16 ] & \\ p ( Y \vert Z ) = p ( Y \vert x , α , μ , W ) = {\prod }_{t = 1}^{τ} N ( {y}_{t} \vert ( f ( t ; α , β , μ ) , {σ}^{2} ) ) = {\prod }_{t = 1}^{τ} N ( {y}_{t} \vert ( {\sum }_{i = 1}^{K} {α}_{i} {φ}_{i} ( t ; {g}_{{β}_{i}} ( x ; W ) ) + μ , ψ ( t ; {g}_{{σ}^{2}} ( x ; W ) ) ) ) = N ( Y \vert {A}_{Y} Z , {Λ}_{Y}^{- 1} ) & ( 17 ) \\ {A}_{Y} = ( \begin{matrix}{φ}_{1 , 1} & … & {Q}_{1 , K} & 1 \\ ⋮ & ⋱ & ⋮ & ⋮ \\ {φ}_{τ , 1} & … & {φ}_{τ , K} & 1\end{matrix} ) & \\ {φ}_{t , i} = {φ}_{i} ( t ; {g}_{{β}_{i} ( x ; W ) )} & \\ {Λ}_{Y}^{- 1} = diag ( {ψ}_{1} , {ψ}_{2} , … , {ψ}_{τ} ) & \\ {ψ}_{τ} = ψ ( t ; {g}_{{σ}^{2}} ( x ; W ) ) & \end{matrix}$$

g_{ß}(x;W) means the combined vector ß obtained when the set value x is input to the parameter model of the weight parameter W. g_{σ2}(x;W) means the constant σ² obtained when the set value x is input to the parameter model of the weight parameter W.

The vector Z is expressed by a Gaussian distribution such as Formula (16), and a posterior distribution of the vector Y with respect to the vector Z follows a conditional Gaussian distribution such as Formula (17). In this case, a posterior distribution of the vector Z with respect to the vector Y can be expressed using a parameter indicating a probability distribution (marginal distribution) of the vector Z and a parameter indicating the posterior distribution of the vector Y with respect to the vector Z. This is shown in Formula (2.116) in “PATTERN RECOGNITION AND MACHINE LEARNING” written by Christopher M. Bishop and published by Springer Science+Business Media in 2006, and so on. Therefore, the probability distribution p(Z|Y) is expressed as follows using the parameters given in Formula (16) and Formula (17).

$$\begin{matrix}[ math . 17 ] & \\ \begin{matrix}p ( Z \vert Y ) = N ( Z \vert \sum ( ( {A}_{Y}^{T} {Λ}_{Y} Y + {Λ}_{Z} {M}_{Z} ) ) , \sum ) \\ = N ( Z \vert {M}_{z}^{′} , \sum )\end{matrix} & ( 18 ) \\ {M}_{z}^{′} = \sum ( {A}_{Y}^{T} {Λ}_{Y} Y + {Λ}_{Z} {M}_{Z} ) & \\ \sum = {( {Λ}_{Z} + {A}_{Y}^{T} {Λ}_{Y} {A}_{Y} )}^{- 1} & \end{matrix}$$

A_{Y}^{T} is a transposed matrix of A_{Y}.

p(α*,μ*|D′*,W) in Formula (12) can be regarded as a posterior distribution p(Z*|Y*) of a vector Z* when a vector Y* is given. Therefore, the following formula holds.

[math. 18]

p(α*,μ*|D′*,W)=N(Z|M′_{z},Σ) (19)

Using the Woodbury formula enables the efficient calculation of N(Z|M_{z}′,Σ). Therefore, p(α*,μ*|D′*,W) can be calculated.

The integration of α* and ρ* of the probability distribution p(Y*ₜ| x*,α*,μ*,W) in the parentheses in Formula (12) can be regarded as a probability distribution (marginal distribution) of the evaluation index y*ₜ in the case where the set value x* is given and the weight parameter W has been sampled and known. Further, since the posterior distribution of the vector Y with respect to the vector Z follows the conditional Gaussian distribution, a posterior distribution p(y*ₜ|Z*) of the vector y*ₜ with respect to the vector Z* also follows the conditional Gaussian distribution. Further, as is seen in Formula (16), a probability distribution (marginal distribution) of the vector Z* also follows the conditional Gaussian distribution. In this case, by using a known conversion method as is shown in Formula (2.115) of “PATTERN RECOGNITION AND MACHINE LEARNING”, the probability distribution (marginal distribution) of the vector y*ₜ can be expressed using a parameter representing the probability distribution (marginal distribution) of the vector Z and a parameter representing the posterior distribution of the vector Y with respect to the vector Z. Therefore, the following formula holds.

[math. 19]

∫∫p(Y*ₜ|X*,α*,μ*,W)da*dμ=p(y*ₜ)

=N(y*ₜ|A_{y*}_{ₜ}M′_{z},Λ_{y*}_{ₜ}⁻¹+A_{y*}_{ₜ}ΣA_{y*}_{ₜ}^{T}) (20)

In this manner, the parenthesis parts in Formula (12) are replaced by Formulas (19) and (20) including neither the connection vector α nor the constant μ. This enables the learning curve prediction without performing the sampling of the connection vector α and the constant μ. Note that, in a case where one of the connection vector α and the constant μ is obtained from the parameter model, the parameter obtained from the parameter model is included in the weight parameter W, and the vector Z may simply be only the parameter not obtained from the parameter model.

As described above, according to this embodiment, the learning curve prediction is enabled even if some of the parameters sampled in the first embodiment are not sampled. This can make the precision of the learning curve prediction higher than in the first embodiment if the calculation time is the same as that in the first embodiment. That is, it is possible to prevent the precision of the learning curve estimation from degrading owing to the sampling of a parameter not suitable for the learning curve prediction, while keeping the time required for the learning curve prediction shorter than in a conventional method.

Note that at least part of the above-described embodiments may be implemented by a specialized electronic circuit (namely, hardware) such as IC (Integrated Circuit) implemented with a processor, a memory, and so on. A plurality of constituent elements may be implemented by one electronic circuit, one constituent element may be implemented by a plurality of electronic circuits, or each of the constituent elements is implemented by one electronic circuit. Further, at least part of the above-described embodiments may be implemented through the execution of software (program). For example, it is possible to implement the processing of the above-described embodiments by, for example, using a general-purpose computer apparatus as basic hardware and causing a processor (Processing circuit, Processing circuitry) such as CPU (Central Processing Unit) and GPU (Graphics Processing Unit) mounted in the computer apparatus to execute the program. In other words, the processor (Processing circuit, Processing circuitry) is configured to be capable of executing the processing of each of the devices by executing the program.

For example, by a computer reading specialized software stored in a computer-readable storage medium, it is possible for the computer to be the device of the above-described embodiments. The kind of the storage medium is not limited. Besides, by a computer installing specialized software downloaded through a communication network, it is possible for the computer to be the apparatuses of the above-described embodiments. In this manner, information processing by the software is concretely implemented using a hardware resource.

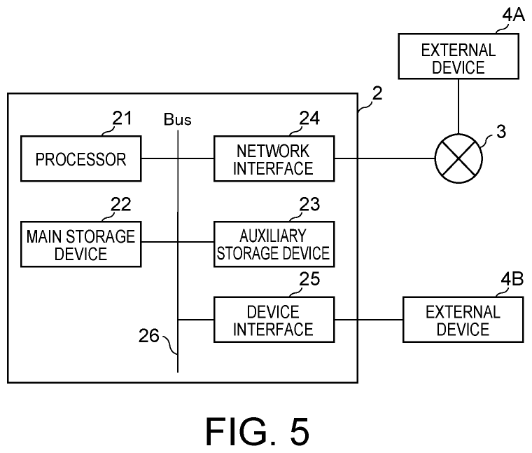

FIG. 5 is a block diagram illustrating an example of the hardware configuration in one embodiment of the present invention. The learning apparatus 1 includes a processor 21, a main storage device 22, an auxiliary storage device 23, a network interface 24, and a device interface 25, and can be implemented as a computer apparatus 2 in which they are connected through a bus 26.

It should be noted that the computer apparatus 2 may include a plurality of the same constituent elements though the number of each of the constituent elements included in the computer apparatus 2 in FIG. 5 is one. Further, the single computer apparatus 2 is illustrated in FIG. 5, but the software may be installed in a plurality of computer apparatuses and the plurality of computer apparatuses may execute different parts of the processing of the software.

The processor 21 is an electronic circuit (processing circuit) including a computer control unit and an arithmetic unit. The processor 21 performs the arithmetic processing on the basis of data and program input from the devices and so on of the internal configuration of the computer apparatus 2 and outputs the arithmetic results and control signals to the devices and so on. Specifically, the processor 21 executes OS (Operating System) of the computer apparatus 2, application, and so on to control the constituent elements included in the computer apparatus 2. The processor 21 is not limited, provided that it is capable of performing the above-described processing. It is assumed that the constituent elements of the learning apparatus 1 except the storage device 11 are implemented by the processor 21.

The main storage device 22 is a storage device storing instructions which are to be executed by the processor 21, various kinds of data, and so on, and information stored in the main storage device 22 is read directly by the processor 21. The auxiliary storage device 23 is a storage device other than the main storage device 22. Note that these storage devices mean any electronic components capable of storing electronic information and may be memories or storages. Further, a memory includes a volatile memory and a nonvolatile memory, and the memories may be either of these. The storage device 11 may be implemented by the main storage device 22 or the auxiliary storage device 23. That is, the storage device 11 may be a memory or a storage.

The network interface 24 is an interface for wireless or wired connection to a communication network 3. As the network interface 24, one conforming to an existing communication protocol may be used. The network interface 24 enables the connection of the computer apparatus 2 and an external device 4A through the communication network 3.

The device interface 25 is an interface such as Universal Serial Bus (USB) which directly connects to an external device 4B. That is, the computer apparatus 2 and the external devices 4 may be connected through a network or directly.

It should be noted that the external devices 4 (4A and 4B) may be any of devices outside the learning apparatus 1, devices inside the learning apparatus 1, external storage media, and storage devices.

While certain embodiments have been described above, these embodiments have been presented by way of example, and are not intended to limit the scope of the inventions. These novel embodiments may be embodied in a variety of other forms, and various omissions, substitutions, and changes may be made therein without departing from the spirit of the inventions. Such forms or modifications fall within the scope and spirit of the inventions and are covered by the inventions set forth in the claims and their equivalents.

### EXPLANATION OF REFERENCE SIGNS

1: learning apparatus (learning curve prediction apparatus), 11: storage device, 12: sampler, 13: learning curve predictor, 14: selector, 15: learning executor, 16: learning curve calculator, 17: decider, 18: output device, 2: computer apparatus, 21: processor, 22: main storage device, 23: auxiliary storage device, 24: network interface, 25: device interface, 26: bus, 3: communication network, 4 (4A, 4B): external devices

1.-11. (canceled)

12. A learning curve prediction apparatus comprising:
a sampler configured to sample a weight parameter of a parameter model, the parameter model providing a parameter of a learning curve model of a neural network based on a set value of a hyperparameter of the neural network;
a learning curve predictor configured to calculate a prediction learning curve of the neural network based on the sampled weight parameter and an actual learning curve of the neural network;
a learning executor configured to advance learning in the neural network; and
a learning curve calculator configured to calculate an actual learning curve resulting from the advance of the learning in the neural network by the learning executor,
wherein the learning curve predictor is configured to update the prediction learning curve of the neural network based on the weight parameter sampled before the learning executor advances learning and the actual learning curve calculated by the learning curve calculator.

13. The learning curve prediction apparatus according to claim 12, wherein:
the set value of the hyperparameter includes a plurality of set values; and
the learning curve predictor is configured to calculate prediction learning curves of a plurality of neural networks corresponding to the plurality of set values,
the learning curve prediction apparatus further comprises a selector configured to select a neural network in which learning is to be advanced, from the plurality of neural networks, based on indexes regarding the prediction learning curves,
the learning executor is configured to advance the learning in the selected neural network;
the learning curve calculator is configured to calculate, as a result of the advance of the learning in the selected neural network by the learning executor, an actual learning curve of the selected neural network; and
the learning curve predictor is configured to update the prediction learning curve of the neural network whose actual learning curve of the learning is calculated as the result of the advance of the learning.

14. The learning curve prediction apparatus according to claim 13, wherein:
an index of the indexes regarding the prediction learning curves is a maximum value out of values each equal to an expected improvement in each epoch which is larger than a current epoch number and is within a range equal to or less than an epoch number upper limit value, divided by a difference value between the each epoch and the current epoch number; and
the selector is configured to select at least a neural network corresponding to a set value under which the index has a maximum value, as the neural network in which the learning is to be advanced.

15. The learning curve prediction apparatus according to claim 13, further comprising
a decider configure to decide at least one of the plurality of neural networks as a promising neural network based on at least one of the prediction learning curve or the actual learning curve.

16. The learning curve prediction apparatus according to claim 15,
wherein the decider is configured to decide an optimum value of the hyperparameter based on the promising neural network.

17. The learning curve prediction apparatus according to claim 15, further comprising
an output device configured to output a result of the decision by the decider.

18. The learning curve prediction apparatus according to 12, wherein
the learning curve predictor is configured to obtain the parameter of the learning curve model from the parameter model in which the sampled weight parameter is set, and
the learning curve predictor is configured to calculate the prediction learning curve based on the actual learning curve and the parameter of the learning curve model.

19. The learning curve prediction apparatus according to claim 18, wherein:
the learning curve model comprises a plurality of basis functions; and
the learning curve predictor is configured to obtain, from the parameter model, the following parameters that are included in the parameter of the learning curve model:
(i) a connection vector representing a weight of each of the basis functions,
(ii) a combined vector of parameter vectors of each of the basis functions,
(iii) a constant of the learning curve model, and
(vi) a variance of noise included in the learning curve model.

20. The learning curve prediction apparatus according to claim 18, wherein:
the learning curve model comprises a plurality of basis functions; and
the learning curve predictor is configured to calculate the prediction learning curve without obtaining, from the parameter model, at least one of a connection vector and a constant of the learning curve model out of the following parameters that are included in the parameter of the learning curve model:
(i) the connection vector representing a weight of each of the basis functions,
(ii) a combined vector of parameter vectors of each of the basis functions,
(iii) the constant of the learning curve model, and
(vi) a variance of noise included in the learning curve model.

21. A learning curve prediction method, comprising the steps of:
sampling a weight parameter of a parameter model, the parameter model providing a parameter of a learning curve model of a neural network based on a set value of a hyperparameter of the neural network;
calculating a prediction learning curve of the neural network based on the sampled weight parameter and an actual learning curve of the neural network;
advancing learning in the neural network;
calculating an actual learning curve resulting from the advance of the learning in the neural network; and
updating the prediction learning curve of the neural network based on the weight parameter sampled before the learning advances and the actual learning curve calculated after the learning advances.

22. A non-transitory computer readable medium for storing program instructions causing a computer to execute:
sampling a weight parameter of a parameter model, the parameter model providing a parameter of a learning curve model of a neural network based on a set value of a hyperparameter of the neural network;
calculating a prediction learning curve of the neural network based on the sampled weight parameter and an actual learning curve of the neural network;
advancing learning in the neural network;
calculating an actual learning curve resulting from the advance of the learning in the neural network; and
updating the prediction learning curve of the neural network based on the weight parameter sampled before the learning advances and the actual learning curve calculated after the learning advances.
